(19) United States
(12) Patent Application Publication
(10) Pub. No.: US 2011/0163475 A1
(43) Pub. Date: Jul. 7, 2011

(54) METHOD FOR PRODUCING ROOFING TILES AND DEVICE FOR PRODUCING SAID ROOFING TILES

(76) Inventors: Benno Boehm, Borken (DE); Peter Chowanietz, Duelmen (DE)

(21) Appl. No.: 12/675,030

(22) PCT Filed: Sep. 9, 2008
(86) PCT No.: PCT/EP2008/061946

§ 371 Date: Feb. 24, 2010

(30) Foreign Application Priority Data
Sep. 11, 2007 (DE) 10 2007 043 163.7

(51) Int. Cl. B28B 1/24; B28C 5/00

(52) U.S. Cl. 264/161; 425/200

(57) ABSTRACT

The invention relates to a method for producing roofing tiles by means of a core shooting device. A core box comprises a mold carrier in the interior thereof. Fresh concrete is introduced into the core box through an injection opening. The core box is ventilated by means of at least one screen nozzle disposed on the mold carrier. The roofing tile produced in the core box is removed from the core box and fed into a cutting device, where protruding burrs of the roofing tile are removed.

The invention relates to a method for the production of roofing tiles according to the preamble of claim 1 as well as to a device for the production of these roofing tiles according to the preamble of claim 16.

In the case of pitched roofs the major portion of the roof surface is covered with flat roofing tiles. However, for the roofing of certain regions of the roof and for satisfying specific technical functions, the flat roofing tiles are installed in combination with accessory tiles. Accessory tiles are, for example, the ridge and arris starting tiles to be installed in the ridge and arris regions as well as the hip caps. Among the accessory tiles with technical function are, in contrast, snow guard tiles, venting tiles and [foot-]standing tiles. Since accessory tiles have markedly more complex geometries compared to flat roofing tiles, the production of flat roofing tiles and accessory tiles prove to be highly different.

Flat roofing tiles are produced using extrusion molding, such as is described in the German [laid open] application DE 35 22 846 A1. Herein green cement is placed onto a continuous belt of bottom dies and pressed into the bottom die by means of a profiled roller such that a continuous belt of compacted green concrete is generated, whose cross sectional profile corresponds to that of the future flat roofing tile. The continuous belt is subsequently cut such that each bottom die bears a single molded flat roofing tile blank. While the extrusion molding method ensures the efficient production of the flat roofing tiles, however only simple geometries can be produced since the forming by means of a roller and a bottom die does not permit providing the flat molded roofing tile blank with contours extending transversely to the direction of extrusion. However, many accessory tiles require such contours.

An alternative method which permits a greater degree of freedom of the forming, is the core shooting method disclosed in EP 1 106 281 B1, in which by means of compressed air a molding material with delayed curing properties is injected into a core box and subsequently removed from it. To inject the molding material, the core box is substantially positioned in a perpendicular with respect to the longitudinal direction of the body to be formed and swivelled substantially into a horizontal for the removal of the molded body. The molding material described in EP 1 106 281 B1 can be a green concrete, whereby the invention can be employed in the production of roofing tiles.

In practice accessory tiles are produced manually which is time consuming and cost intensive. Ridge and arris starting tiles are produced using a two-part molding box, wherein the lower half of the molding box forms the underside and the upper half of the molding box the upper side of the ridge or arris starting tile. After placing the green concrete manually into the lower half, the upper half of the molding box is placed onto it and pressed against it. The densification of the green concrete subsequently takes place thereby that the molding box is placed onto a vibrating table. Depending on the dwelling time on the vibrating table, the densification of the green concrete yields different results such that the ridge and arris starting tiles vary with respect to their freeze-thaw cycling resistance.

The methods for the production of snow guard tiles, venting tiles and standing tiles are very similar. In the production of snow guard tiles, first, a rib serving as a snow barrier is formed from the green concrete, which rib subsequently is adhered in the foot-end region onto the top side of the flat roofing tile. The production of standing tiles takes place by prefabricating the bracket comprising the climbing step and adhering it onto the roofing tile. For the production of a venting tile, a venting opening is cut centrally out of the flat roofing tile, which opening is subsequently covered with a separately fabricated venting hood against the penetration of rain. For this purpose the venting hood is adhered onto the top side of the flat roofing tile. The adhesive bonding in such accessory tiles represents a mechanical weak spot, which tends toward the formation of cracks. Through the penetration of moisture, frost bursting can occur and the further weakening of the adhesive bond. Under the action of an external force, for example when a roofer walks on the roof during an inspection, there is the risk that the adhered joined part (snow barrier, bracket, venting hood) become detached from the flat roofing tile. Since the flat roofing tiles and the joined parts are produced separately, their color coatings are also carried out independently of one another. The color of the flat roofing tiles and that of the joined parts therefore vary such that the finished accessory parts also do not exhibit a uniform appearance. It is not possible to produce a faultless esthetic appearance even with an additional color coating of the finished accessory tile.

The present invention therefore addresses the problem of providing a method and an installation which make feasible the economically more efficient production of accessory roofing tiles and simultaneously the enhancement of the quality of the produced accessory structural tiles.

The problem addressed by the invention is resolved according to the features of patent claims 1 and 16.

The invention thus relates to a method for the production of roofing tiles by means of a core shooter [device]. Herein a core box is provided which includes in its interior a mold carrier. Through an injection opening of the core box green concrete is introduced into the core box. Venting the core box takes place via at least one screen nozzle disposed in the mold carrier. The roofing tile generated in the core box is removed from the core box and transferred to a cutting device, where projecting burrs of the roofing tile are cut off

According to the invention the green concrete is shot or injected at high kinetic energy via a compressed air percussion into the molding box of a core shooter for the production of accessory tiles, whereby a compaction is attained that is markedly higher than is the case when using the conventional densification of the green concrete on a vibrating table. Due to the higher compaction of the green concrete, the accessory tiles have a lesser porosity and therewith a higher freeze-thaw cycling resistance (according to DIN EN 490, tested according to DIN EN 491).

Since the cavity of the molding box receiving the green concrete corresponds to the finished accessory tile, monolithic accessory tiles are generated. The separate production and the time-consuming adhesion of flat roofing tiles and joined parts become superfluous, and the accessory tile accordingly also no longer has a weakening adhesive bond.

After the injection step, the molding box can be removed from the core shooter and be disassembled. The accessory tile is subsequently removed from the molding box and transferred promptly to a coating station, such that the color application takes place on the still wet green concrete of the not yet cured accessory tile. This process is referred to as wet coating. Color variations, such as were previously unavoidable due to the separate color coating of the flat roofing tiles and of the joined parts, are in this way avoided. Wet coating, moreover, permits the optimal cross-linking of the coloring agent, which conventionally is a polymer dispersion coloring agent, with the surface of the accessory tile such that improved adhesion and durability of the color coating is attained. A single color application is sufficient for an esthetic appearance of the accessory tile.

Several embodiments of the invention will be explained in conjunction with the Figures and explained in the following in further detail. In the drawing depict:

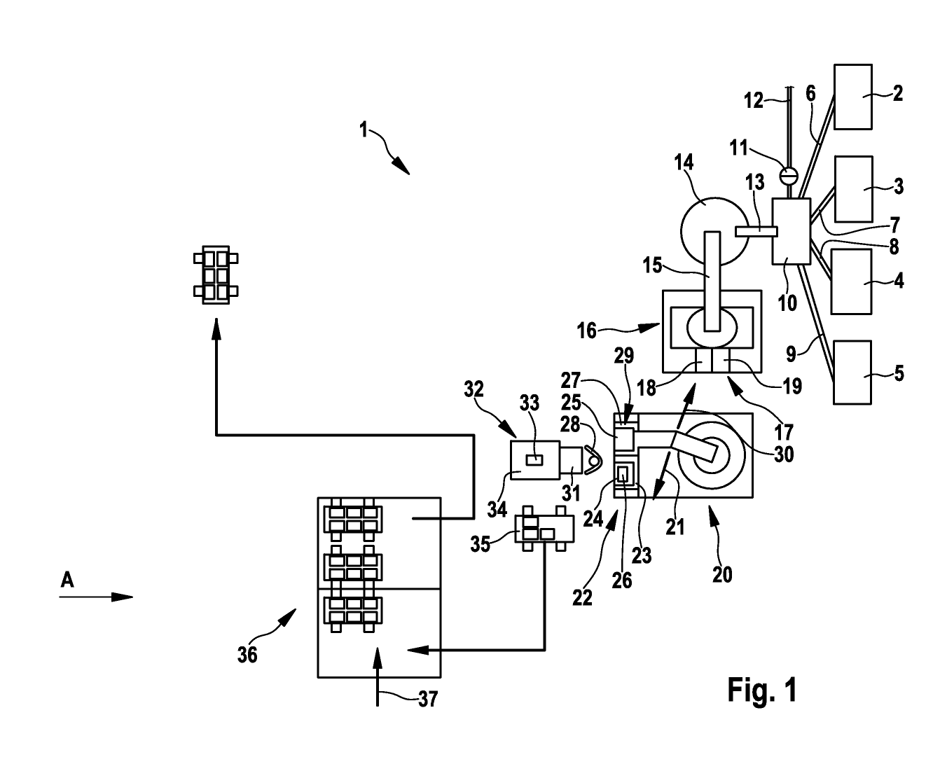

FIG. 1 an installation for the production of accessory tiles in schematic representation;

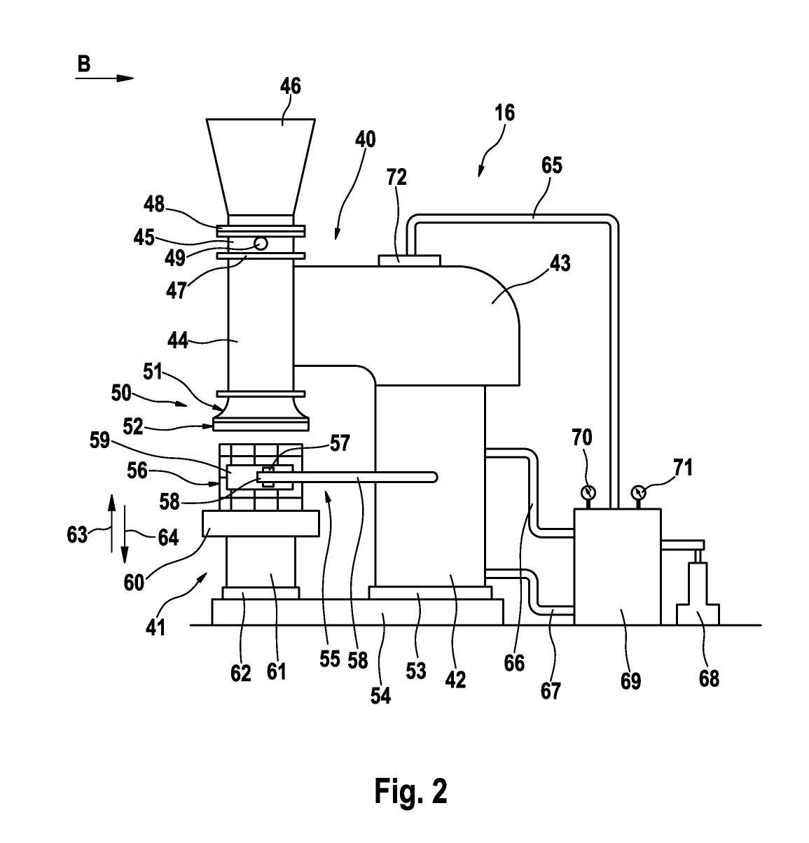

FIG. 2 a side view of a core shooter with a core box located within the installation shown in FIG. 1;

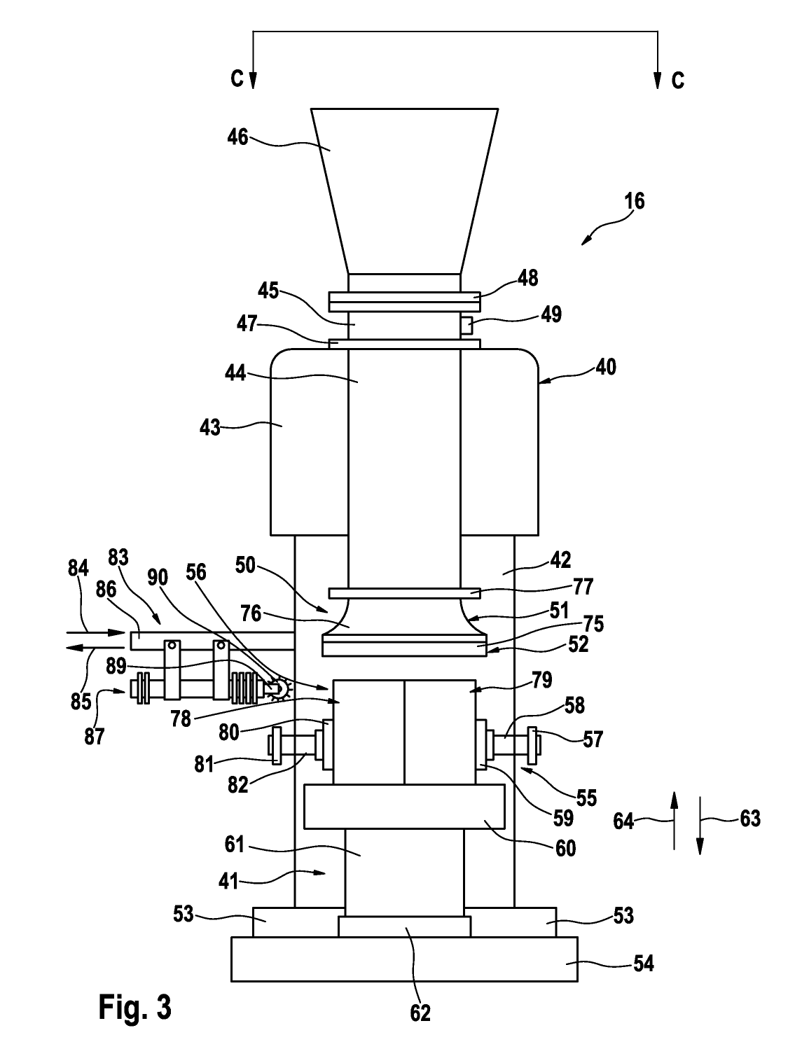

FIG. 3 a front view of the core shooter shown in FIG. 2 with core box viewed in direction B;

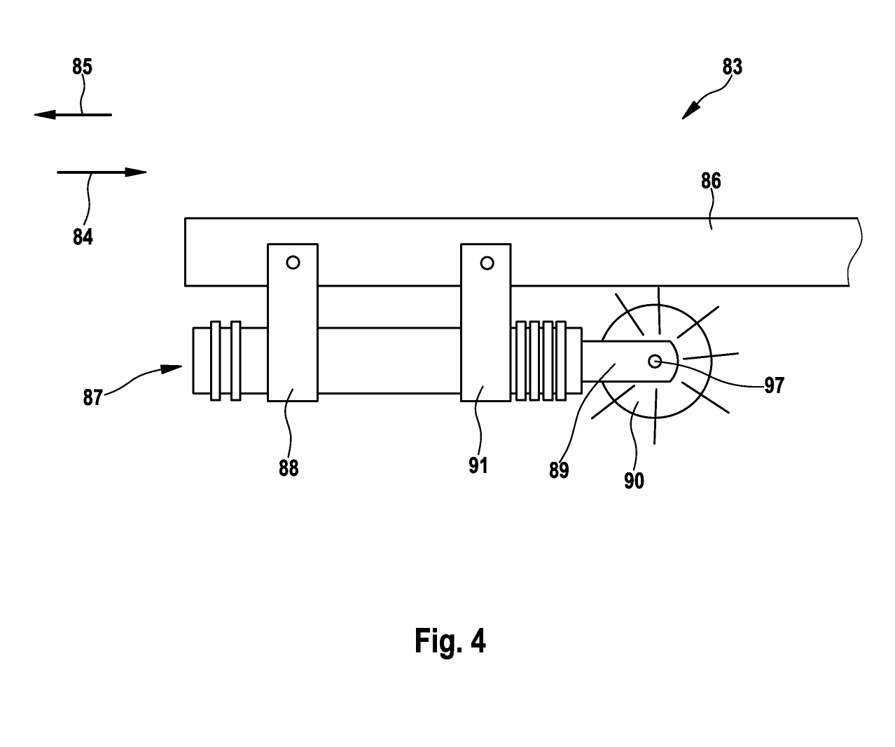

FIG. 4 a re-pressing unit;

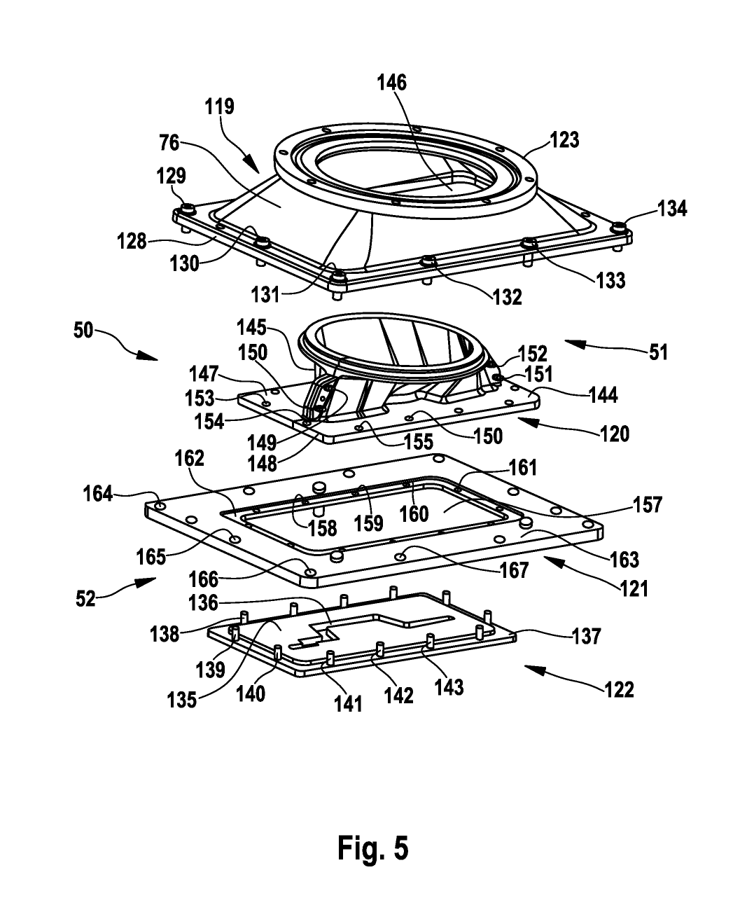

FIG. 5 an exploded representation of a shooting unit;

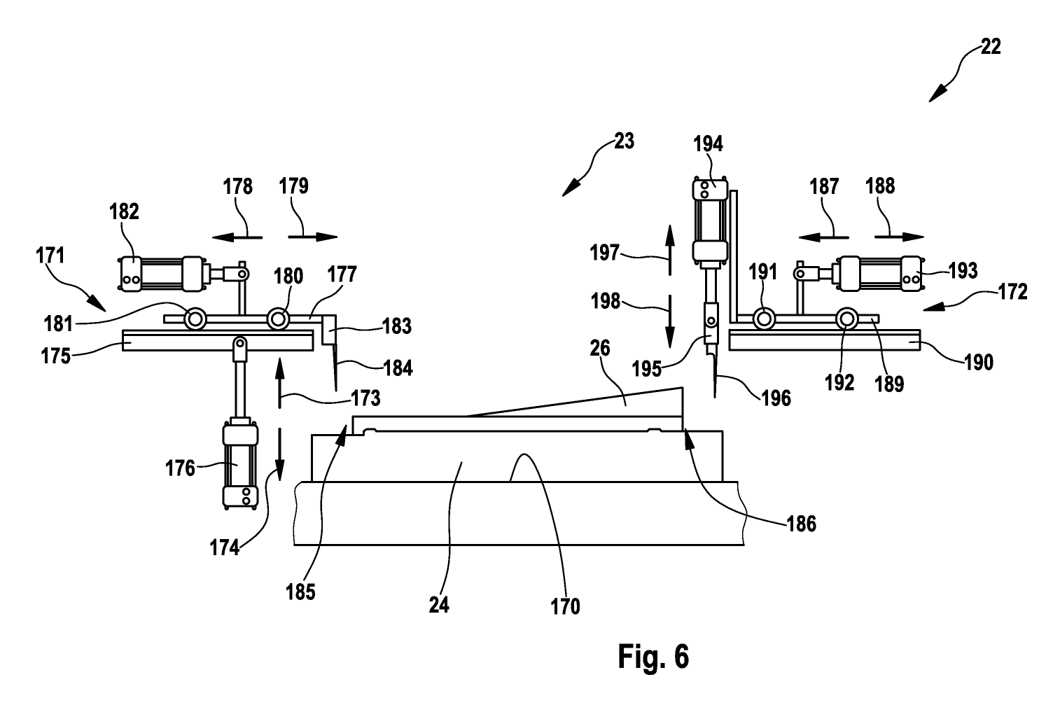

FIG. 6 two cutting tools disposed in a receiving device according to FIG. 1;

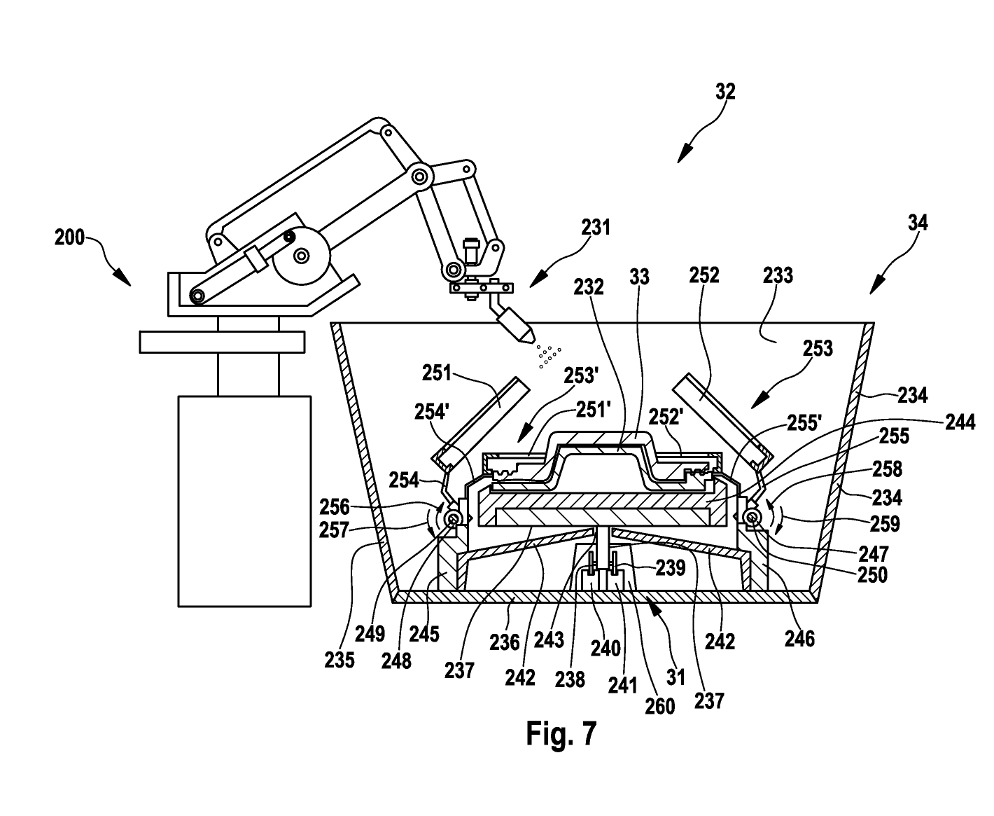

FIG. 7 a color coating installation of the installation according to FIG. 1;

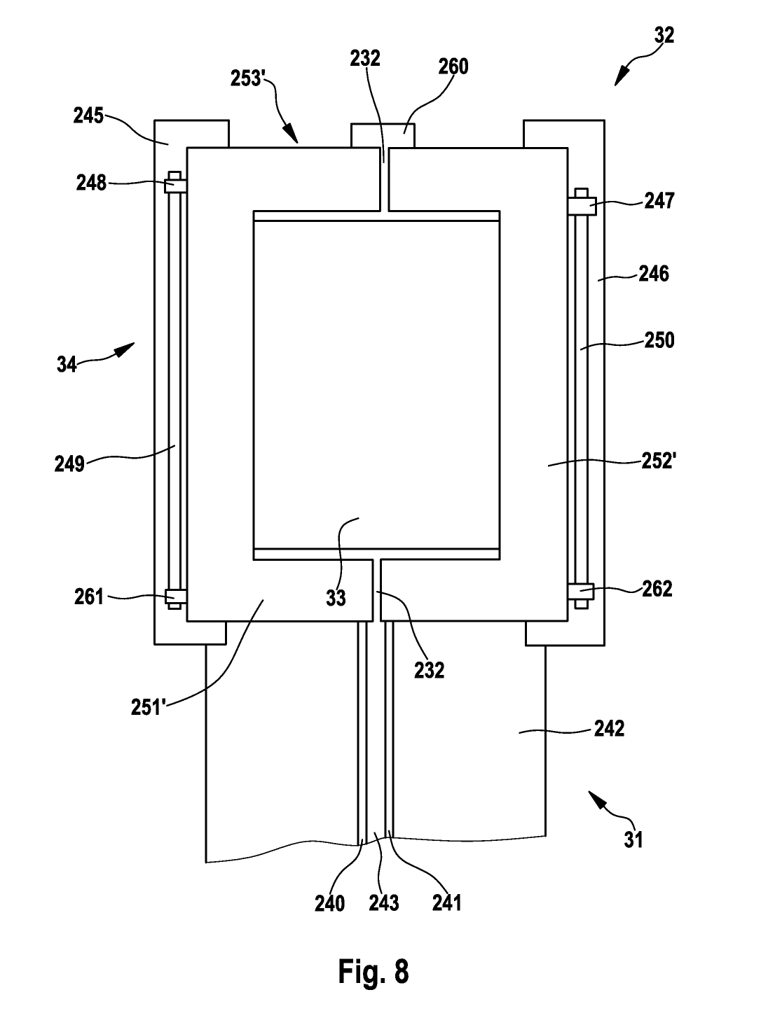

FIG. 8 a top view onto a spray chamber disposed in the color coating installation according to FIG. 7;

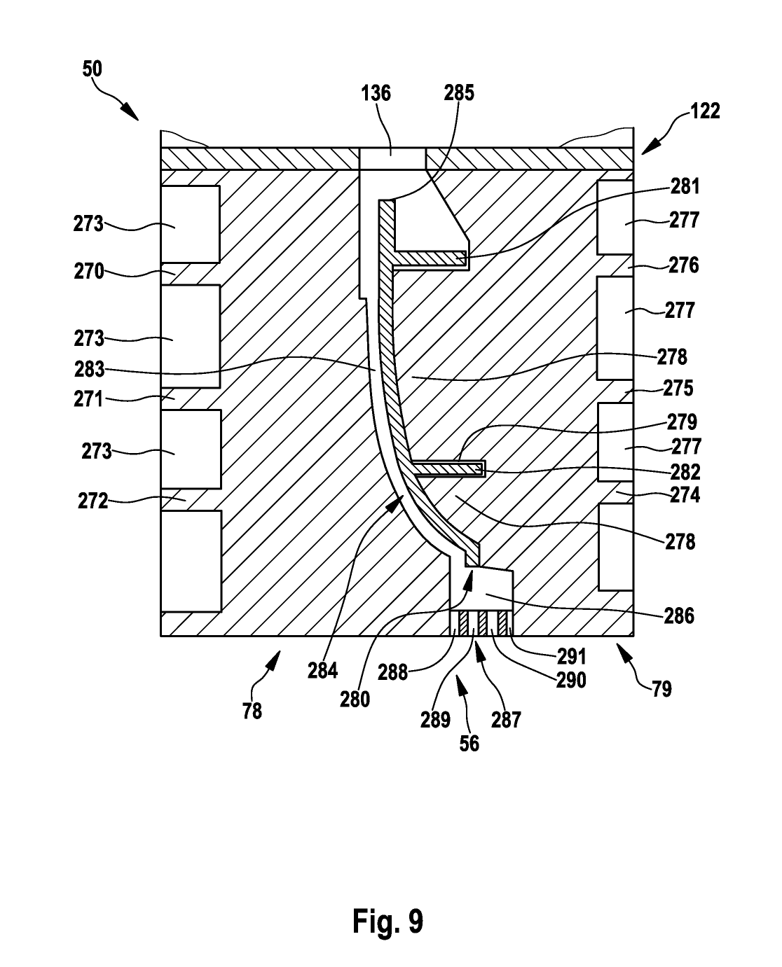

FIG. 9 a section C-C through the core box shown in FIG. 3 with a portion of the core shooter according to FIG. 3;

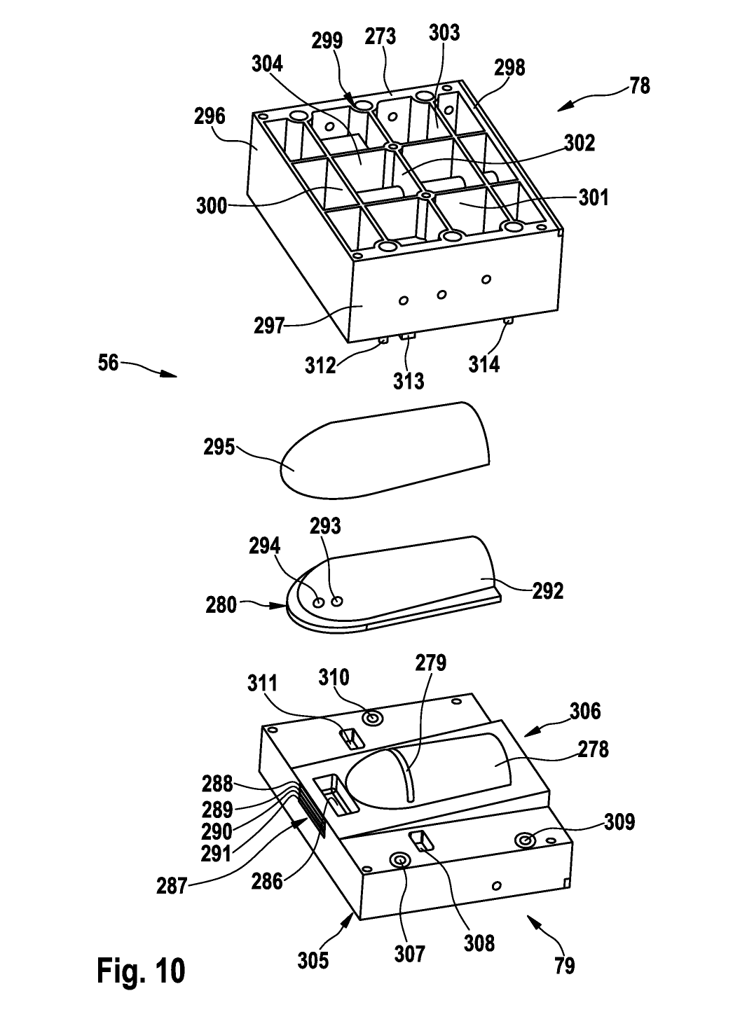

FIG. 10 an exploded representation of the core box shown in FIG. 9;

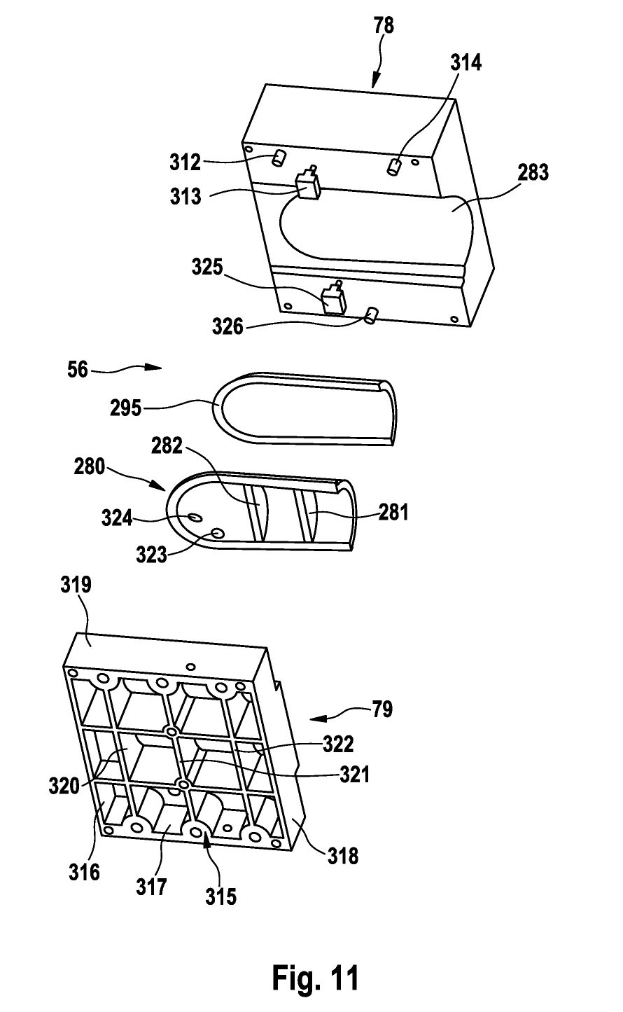

FIG. 11 a different view of the core box according to FIG. 10;

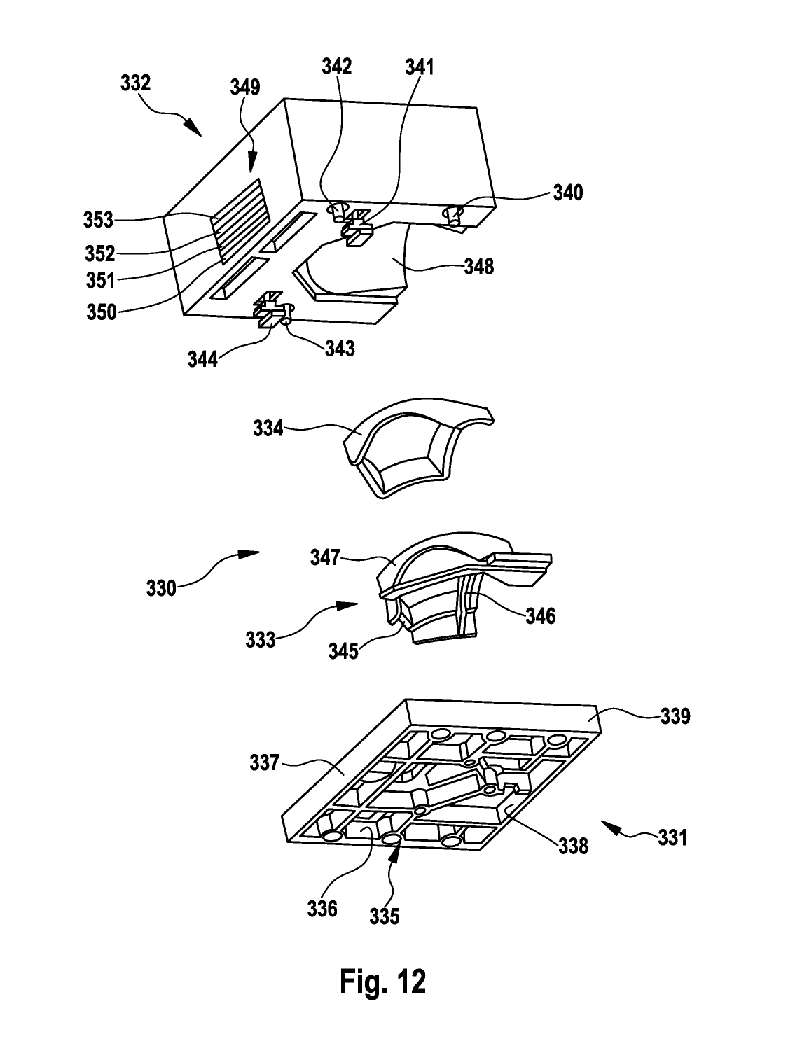

FIG. 12 an exploded representation of a variant of the core box shown in FIG. 10;

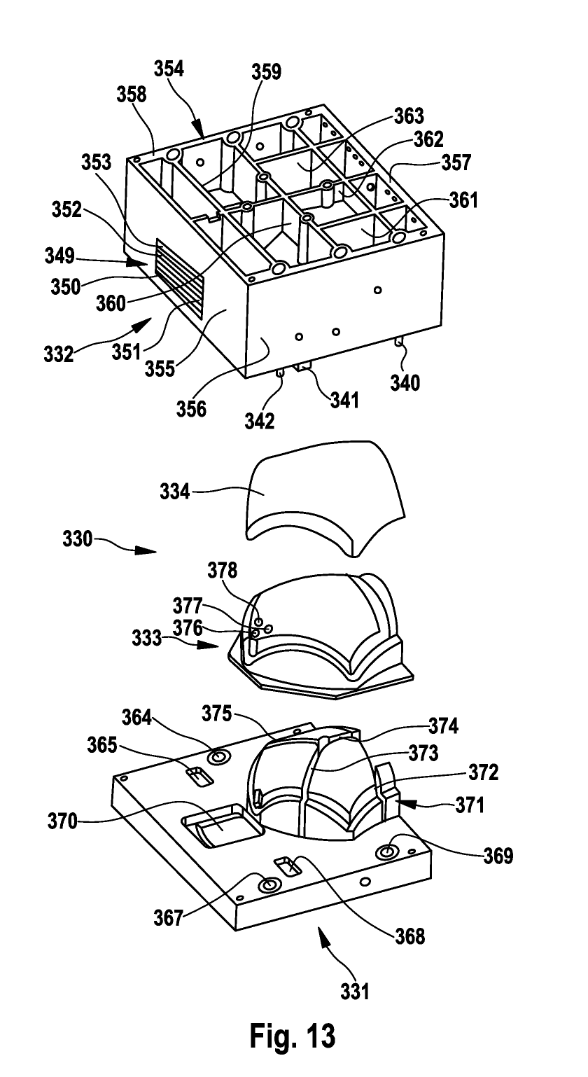

FIG. 13 a different view of the core box according to FIG. 12;

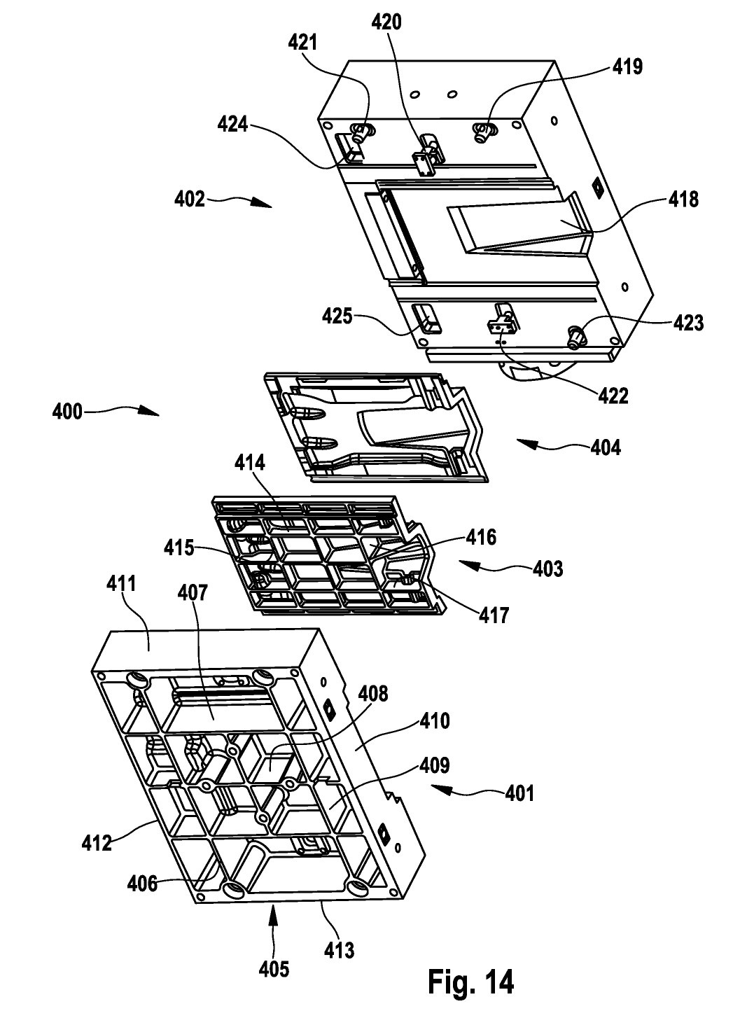

FIG. 14 an exploded representation of a further variant of the core box shown in FIG. 10.

FIG. 1 depicts schematically an installation 1 for the production of accessory tiles. The method for the production of accessory tiles will be described in the following in conjunction with FIG. 1. The installation 1 comprises four silos 2 to 5, in which the components for the production of a green concrete mixture are stored. The silo unit 2 contains pigments and additives, the silo unit 3 sand of several particle-size distribution curves, the silo unit 4 cement and the silo unit 5 aggregates. The silo units 2 to 5 are connected via worm conveyors 6 to 9 with a weighing and dosing device 10, such that the components can be supplied from the silo units 2 to 5 to the weighing and dosing device 10. The weighing and dosing device 10 is furthermore connected to a water conduit 12 provided with a shut-off valve 11, via which conduit the water can be obtained which is required for mixing the green concrete mixture. Part of the weighing and dosing device 10 is a computing unit in which the formula for the green concrete mixture is stored and with which the worm conveyors 6 to 9 and the shut-off valve 11 can be driven. The weighing and dosing device 10 can in this manner assemble the individual components according to the formula and supply them to a mixer 14 via a feed line 13. To the mixer 14 are first supplied the solid components and, with the start of the mixing process, the addition of the liquid components, thus of the water and of the additives, takes place. The components are thoroughly mixed for approximately three minutes in the mixer 14.

The mixture has the following composition:

sand (type 0/3, Producer: CWS) 45 to 75 wt %, especially preferred 54.13 wt %,

sand (type 0.5/2, producer: CWS): 0 to 24 wt %, especially preferred 11.4 wt %,

quartz sand (type L 55, producer: Quarzwerke): 0 to 30 wt %, especially preferred 5.7 wt %,

cement (type CEM II 52.5, producer: Holcim): 18 to 25 wt %, especially preferred 20.89 wt %,

additive (type FK 61, producer: MC Bauchemie): 0.2 to 1.4 wt %, especially preferred 0.47 wt %,

additive (type BWA 22, producer: MC Bauchemie): 0.2 to 0.8 wt %, especially preferred

coloring agent (type granite, producer: Lanxess): 0.3 to 1.0 wt %, especially preferred 0.5 wt %.

The pot life of the green concrete mixture is approximately 20 minutes. After this time its processing property is impaired, which can have a negative effect on the product quality. The pot life is thus the time between mixing a multi-component substance and the end of its processibility, thus the time interval in which the substance can still be “removed from the pot” and processed. The end of the pot life is most frequently indicated by a marked viscosity rise, which prevents further processing. It is therefore recommended to produce each time only a small green concrete quantity of approximately 50 to 100 kg, which can be quickly used up. The produced green concrete is transferred from the mixer 14 to an extraction belt 15 and from it is supplied to a core shooter 16. The core shooter 16 is described in greater detail in FIGS. 2 to 5. In the core shooter 16 can be seen an upright core box 17. This core box 17 is comprised of a first box part 19, the so-called upper core box 19, and a second box part 18, the so-called lower core box 18. The details of a core box will be described later in FIGS. 9 to 14.

Injecting the green concrete into the core box 17 takes place through a compressed air percussion. Through the entering air stream the green concrete is herein converted into a two-phase mixture of compressed air and concrete particles. The concrete particles are entrained by the air stream via an injection opening, not visible here, into the core box 17, where they are strongly compacted due to their high kinetic energy. The high compaction leads to a porosity or bulk density of the accessory tiles of approximately 16% to 18% (measured according to DIN 52102), which lends high freeze-thaw cycling resistance to the accessory tiles. For the injection of the green concrete the compressed air should have a pressure of at least 4·10⁵ Pa. Optimal results are achieved at pressures of approximately 6·10⁵ Pa to 10·10⁵ Pa. This pressure should at least be maintained for one second, however no longer than five seconds. The pressure is preferably maintained for one to three seconds.

Using a hydraulic lifting cylinder the filled core box 17 is lowered after the injection process into the core shooter 16. Since the green concrete has a lesser compaction in the region of the injection opening of the core box 17, the green concrete located in the injection channel must be re-pressed by means of a re-pressing unit. This re-pressing unit will be described in the context of FIGS. 4 and 5. The filled core box 17 is removed from the core shooter 16 by a robot unit 20 and transferred into a handling station 22 through a first rotational movement in the direction of arrow 21. In the handling station 22 several procedure steps are performed, which will be described in the following.

The handling station 22 includes a first receiving device 23, into which the robot unit 20 places the filled core box 17. After the placement, the robot unit 20 releases pneumatically the upper core box 19 and the lower core box 18. Such released core box comprised of a first lower core box 24 and a first upper core box 25 can be seen in FIG. 1. The first lower core box 24 is herein depicted with an injected accessory tile 26 in the first receiving device 23. The first upper core box 25 is raised by the robot unit 20 and moved into a second receiving device 27. Here, the first upper core box 25 has been lowered onto a second lower core box, not visible in FIG. 1, into which box a mold carrier has already been placed by personnel 28. The robot unit 20 latches the first upper core box 25 with the second lower core box, whereby a second core box 29 is formed, which can be transferred to the core shooter 16 by the robot unit 20 performing a second rotational movement in the direction of arrow 30.

Before the accessory tile 26 can be removed from the first lower core box 24 located in the first receiving device 23, the burrs at the head- and foot-end margin of the accessory tile 26 are cut off the accessory tile 26 using cutting devices. These cutting devices will be described in detail in FIG. 6. After the cutting process, the accessory tile 26 located on a mold carrier is manually removed from the first lower core box 24 and deposed on a conveyor means 31 which transfers the accessory tile 26 to a color coating installation 32 for the purpose of wet coating.

To ensure high molding accuracy the lower core boxes and the upper core boxes are cleaned after every third injection process. As a rule, the length of an injection process is 45 seconds. The cleaning is completed using a compressed air jet or water vapor jet. Further, a parting agent is applied to avoid adhesions of the accessory tile in the core box. As parting agent can be utilized, for example, a bio-oil, with the application quantity being preferably approximately 1 g. This application can be carried out manually or by machine.

In the color coating installation 32 is already an accessory tile 33, which had been transported by the conveyor means 31 into a spray chamber 34 and been positioned beneath a movable nozzle arrangement. Since the accessory tile, seen in top view, only overlaps the mold carrier partially, the non-covered regions of the mold carrier are masked with the aid of a template in order for the mold carrier not to be contaminated with the coloring agent (FIGS. 7 and 8). As soon as the template has been positioned, the movable nozzle arrangements travels over the entire profile of the accessory tile, wherein the polymer dispersion coloring agent is applied. The quantity of coloring agent is herein at least 15 g per accessory tile. Since the compacted green concrete of the accessory tile is still moist, an especially good cross-linkage between the polymer dispersion coloring agent and the surface of the accessory tile is obtained whereby a durable coating is generated. After termination of the coating process, the accessory tile 33 is again removed from the spray chamber 34 by the conveyor means 31 in order for it to be manually transferred into a drying chamber trolley 35.

As soon as the drying chamber trolley 35 is completed loaded with accessory tiles, it is driven into a drying chamber 36 where the accessory tiles are cured over a dwelling time of 6 to 10 hours and at a temperature between 45° to 60° C. To attain complete hydration, to the drying chamber 36 water vapor is supplied at regular intervals during the curing process, which is indicated by an arrow 37. The relative air humidity is thereby kept in a range of 65 to 90%. At the end of the dwelling time the accessory tiles have a sufficiently high solidity permitting the detachment of the accessory tiles from the mold carrier.

Since the thus produced accessory tiles comprise monolithically only one material, they have the same surface quality everywhere. The cured accessory tile is now preferably manually detached from the mold carrier, the so-called pallet. This detachment of the accessory tile from the mold carrier is referred to as stripping. After they have been stripped from the mold carrier, the accessory tiles can be transferred to further work stations, not depicted in FIG. 1, such as for example to a packing station.

FIG. 2 shows the core shooter 16 comprising a main component 40 as well as a lifting cylinder 41. Both, the main component 40 as well as the lifting cylinder 41 are disposed on a pedestal 54. The main component 40 is comprised of a machine stand 42, a center part 43 as well as a cylinder 44. Above the cylinder 44 is located a connection element 45 serving as a dosing element, which connects the cylinder 44 with a funnel 46. The connection element 45 is herein connected with the cylinder 44 via a ring 47 and with the funnel 46, via a flange 48.

Further can be seen in FIG. 2 that the connection element 45 includes a switching element 49. At the lower section of the cylinder 44 is disposed a shooting unit 50. This shooting unit 50 is comprised of a shooting head 51 as well as a shooting plate 52. The machine stand 42 is disposed in a base 53, which is fixedly connected with the pedestal 54. On the machine stand 42 is disposed a clamping device 55 to hold a core box 56. This clamping device 55 is substantially comprised of two opposing arms connected with their one end to the machine stand 42 and include at their other end a holding jaw located on an articulation. In FIG. 2 only one arm 58 can be seen, which at its one end is connected to the machine stand 42 and includes at the other end a holding jaw 59 disposed on an articulation 57. The core box 56 is herein held between the holding jaws of the clamping device 55. Both holding jaws are movably disposed on the arms via the articulations.

Core box 56 is disposed on a support plate 60 of lifting cylinder 41. This support plate 60 is located on a cylinder 61 which is anchored in a base 62. The lifting cylinder 41 can be moved by means of an hydraulic force in the direction of arrows 63 and 64. Therewith it becomes feasible to move the core box 56 on the support plate 60 either in the direction toward the shooting unit 50 or to move the core box 56 away from this unit. The center part 43 as well as the machine stand 42 are each connected across conduits 65 to 67, for example pipes, with a pump device 69 driven by a motor 68. On the pumping device 67 can be seen two manometers 70, 71. By means of the pump device 69 it is possible to supply compressed air to the core shooter 16 via the conduits 65 to 67 or to extract this [air] again from the core shooter 16. As can be seen in FIG. 2 conduit 65 is connected with the center part 43 across a cap 72. The conduits 65 to 67 include intake and discharge valves, which, however, are not depicted here.

FIG. 3 depicts a front view of the core shooter 16 shown in FIG. 2, with view in direction B. Seen can again be the main part 40 as well as the lifting cylinder 41 disposed on pedestal 54. The main part 40 is comprised of the machine stand 42, the center part 43 and the cylinder 44. Seen can be further the funnel 46 which is connected via the flange 48 with the connection element 45. This connection element 45 includes the switching element 49 which can be, for example, a wheel or a lever. In FIG. 3 the switching element 49 is formed as a wheel. At the lower end of cylinder 44 is disposed the shooting unit 50, which is comprised of a lower part 75, a central part 76 and an upper part 77. The shooting head 51 is connected via the upper part 77 with the cylinder 44. At the lower part 75 is located the shooting plate 52. This shooting plate 52 is connected with the shooting head 51 via connection elements which are not depicted here. The shooting head 51 is also affixed on cylinder 44 via connection elements. These connection elements are also not visible in FIG. 3. The core box 56 comprising an upper core box 78 and a lower core box 79, is held by the clamping device 55. This clamping device 55 includes holding jaws 59, 80, which are movably disposed on arms 58, 82 via articulations 57, 81.

Furthermore can be seen in FIG. 3 a re-pressing unit 83 which includes an extension [beam] 86 disposed laterally on machine stand 42, on which extension is disposed a pneumatic cylinder 87. The pneumatic cylinder 87 comprises a piston rod 89 movable in the direction of arrows 84, 85, in the free end of which a rotatable press-on roller 90 is inserted. The piston rod 89 with the press-on roller 90 disposed thereon is moved for the re-pressing in the direction of arrow 84, e.g. in the direction of core box 56. The press-on roller 90 is subsequently rolled out on the front side of core box 56 whereby the green concrete in the region of the injection opening is compacted. However, the injection opening is not visible in FIG. 3.

FIG. 4 depicts once again in detail the re-pressing unit 83 described in FIG. 3. Seen can be the extension 86 on which is disposed the pneumatic cylinder 87 by means of mountings 88, 91. On the pneumatic cylinder 87 is disposed the piston rod 89 which at its free end has a gap into which the press-on roller 90 is inserted. The press-on roller 90 disposed in the gap of piston rod 89 is fastened rotatably by means of a connection element 97. This connection element 97 can be, for example, a pin. The gap is not visible in FIG. 4. As depicted in FIG. 4, the press-on roller 90 can be implemented in the form of a cylinder as a brush.

FIG. 5 shows an exploded representation of the shooting unit 50. The shooting unit 50 includes a receiver 119 for an inset 120 as well as two-plate-shaped elements 121, 122. The receiver 119 and the inset 120 form the shooting head 51 and the two plate-shaped elements 121, 122 form the shooting plate 52. The receiver 119 includes an annular first flange 123, which by means of fastening elements is attached on cylinder 44 of the core shooter 16 (cf. FIG. 3). Beneath the annular first flange 123 is disposed the cone-shaped central part 76. Adjoining this central part 76 is a frame-shaped flange 128 into which several connection elements 129 to 134 are inserted.

In FIG. 5 can also be seen the inset 120 which can be introduced with its upper section 145 disposed on a plate-like part 144 into an opening 146 of the receiver 119. The inset 120 includes two interconnectable parts 147, 148. These parts 147, 148 are connected with one another by means of connection elements 149 to 152. In the lower plate-shaped part 144 are located several openings 153 to 156. The inset 120 is preferably comprised of hard metal.

The plate-shaped element 121 includes an opening 157 in its center. This opening 157 is encompassed by a border strip 162 provided with openings 158 to 161. This border strip 162 of opening 157 is encompassed by a frame 163 which is also provided with several openings 164 to 167. Compared to frame 163, the border strip 162 is thinner, such that this border strip 162 forms a support-plate surface for the plate-shaped part 144 of inset 120, whereas the frame 163 forms a support surface for receiver 119. The inset 120 rests subsequently on the border strip 162 such that the openings 153 to 156 are located precisely above openings 158 to 161.

The plate-shaped element 122 has in its central plateau 135 an opening 136 through which concrete from the core shooter 16 can reach a core box. This opening 136 is consequently the opening of the shooting unit 50. The element 122 comprises a margin section 137 with several connection elements 138 to 143 which can engage into the openings 158 to 161 of the plate-shaped element 121 and the superjacent openings 153 to 156 of inset 120, whereby the elements 121, 122 and inset 120 are firmly connected with one another.

The shooting unit 50 is formed by placing the receiver 119 onto the plate-shaped element 121 and introducing the connection elements 129 to 134 into openings 164 to 167 of frame 163. The shooting unit 50 can consequently be simply removed from cylinder 44 of the core shooter 16 and be disassembled. Maintenance of the shooting unit 50 is therefore simple.

FIG. 6 shows a detail of the receiving device 23 according to FIG. 1 of handling station 22 when viewed in direction A. In this receiving device 23 is located the lower core box 24 with the accessory tile 26 disposed thereon on a support surface 170. The accessory tile 26 shown in FIG. 6 is a venting tile. Due to the parting line between upper and lower core box the accessory tile 26 has burrs. At least the burrs on the head- and foot-end edge 185, 186 of the accessory tile 26 must be removed from the accessory tile 26.

For this purpose two cutting devices 171, 172 are disposed laterally of the receiving device 23, each of which cutting devices includes a cutting tool 184 and 196, respectively. The cutting tools 184, 196 are of different structure such that the cutting tool 184 working the head-end edge 185 carries out a simple straight cut and the cutting tool 196 working the foot-end edge 186 during the straight cut performs additionally a compaction of the cut edge.

The cutting device 171 has movable tracks 175 which can be moved via a lifting device 176 in the direction of arrows 173, 174. On the tracks 175 is visible a carriage 177 disposed on wheels, which can be moved in the direction of arrows 178, 179. The carriage 177 has, for example as in FIG. 6, four wheels, wherein two wheels are in each case opposite one another, such that in FIG. 6 only the wheels 180, 181 can be seen. The carriage 177 is connected to a driving mechanism 182, by means of which the carriage 177 can be moved on the tracks 175 in the direction of arrows 178, 179.

At the end of carriage 177 is disposed a removable insert 183 for the exchangeable cutting tool 184. With this cutting tool 184 the burr on the head-end edge 185 of accessory tile 26 is removed. For this purpose through movement of the carriage 177 in the direction of arrow 179 the cutting tool 184 is disposed precisely above the site at which the burr adhering on the accessory tile 26 must be cut off. Subsequently the tracks 175 with the carriage 177 disposed thereon are lowered in the direction of arrow 174. The cutting tool 184 penetrates therein the end of the green concrete and cuts this from the accessory tile 26 proper. By moving the carriage 177 in the direction of arrow 178 the green concrete cut off the accessory tile 26 is removed from the lower core box 24.

The cutting device 172 has a similar constructional setup as the cutting device 171. In the case of cutting device 172 a carriage 189 movable in the direction of arrow 187, 188 is disposed on tracks 190. The carriage 189 includes wheels of which only wheels 191, 192 can be seen since the other two wheels which can not be seen, are oppositely located. The carriage 189 is connected with a driving mechanism 193 by means of which the carriage 189 can be moved in the direction of arrows 187 and 188.

On the end of carriage 189 facing the receiving device 23 (FIG. 1) is disposed a lifting device 194 on which by means of an insert 195 the removable cutting tool 196 is fastened. By means of this lifting device 194 the cutting tool 196 can be moved in the direction of arrows 197, 198.

By moving the carriage 189 in the direction of arrow 188 the cut-off green concrete is removed from the accessory tile 26 and pushed from the lower core box 24. Both cutting devices 171, 172 preferably operate synchronously. Once the green concrete is removed from the lower core box 24, the two cutting devices 171, 172 move back into the initial position as shown in FIG. 6.

Although in FIG. 6 only two variants of cutting devices are shown, other variants are also feasible. It is herein only important that the cutting tools 184, 196 of the particular cutting device 171, 172 can be moved in a horizontal direction, e.g. in the direction of arrows 178, 179 and 187, 188, respectively, and in a vertical direction, e.g. in the direction of arrows 173, 174 and 197, 198, respectively.

Thereby that during the cutting process the cutting tools 184, 196 are also pressed against the accessory tile 26, before they remove the cut-off green concrete from the lower core box 24, the cutting devices 171, 172 also serve for re-pressing the accessory tile.

FIG. 7 shows the color coating installation 32, in which the accessory tile 33, here a venting tile, is to be coated with a polymer dispersion coloring agent. A spray chamber 34 open toward the top can be seen, next to which a robot unit 200 is disposed comprising a nozzle arrangement 231. The nozzle arrangement 231 can be moved by means of the robot unit 200 within the spray chamber 34. The robot unit 200 is driven by a computing unit, not depicted in FIG. 7, in which the contours of the various accessory tiles are stored. In this manner the nozzle arrangement 231 can be guided following the contour of the accessory tile 26, such that an optimal coloring agent application takes place. Since this robot unit is a commercially available model (Model Fanuc S12 by KC Robotics, Fairfiled, Ohio, USA), a detailed description of this robot unit 200 is here omitted. With respect to robot units, reference is also made to A. Redford and E. Lo, “Montageroboter”, VCH-Verlag, 1992.

The accessory tile 33 located on a mold carrier 232 has been transferred into the spray chamber 34 via the conveyor means 31. The rear wall 233 can be seen as well as the two side walls 234, 235 and the bottom 236 of the spray chamber 34. The conveyor means 31 is comprised of a T-shaped carriage 237 disposed on wheels, wherein in FIG. 7 only wheels 238, 239 can be seen. These wheels 238, 239 are disposed on tracks 240, 241 such that the carriage 237 can be driven into the spray chamber 34 and out of it again. At the site at which the tracks 240, 241 do not extend further, a stop bar 260 is provided. This stop bar 260 can be implemented as a block. A hood 242 with a through-hole 243 serves the carriage 237 as a guidance element. On the carriage 237 is located a support plate 244 on which is located the mold carrier 232 with the accessory tile 33 disposed thereon.

Further can be seen walls 245, 246 extending parallel to both sides of the hood 237. At each of the upper front ends of these walls are disposed bearings for an articulation rod 249, 250. Of the bearings only bearings 247, 248 can be seen in FIG. 7. On the articulation rods 249, 250 are each disposed two coverings 251, 252, which, together, form a template 253. This template 253 serves for masking the area of the mold carrier 232 on which the accessory tile does not rest. The accessory tile 33, however, is not masked by the template 253. The coverings 251, 252 are connected with the particular articulation rod 249 and 250, respectively, via webs 254, 255. Via a drive, not depicted here, the articulation rods 249, 250 with the coverings 251, 252 disposed thereon can be moved in the direction of arrows 256, 257 and 258, 259, respectively. The movement takes herein place synchronously, e.g. the covering 251 is moved in the direction of arrow 257 when the covering 252 is moved in the direction of arrow 259, or the covering 251 is moved in the direction of arrow 256 when the covering 252 is moved in the direction of arrow 258.

If the accessory tile 33 is now to be coated with polymer dispersion coloring agent, the covering 251 is moved in the direction of arrow 256 and the covering 252 in the direction of arrow 258. As soon as the template 253 masks the region of the mold carrier 232 not covered by the accessory tile, the robot unit 200 can carry out the coloring agent application by means of the nozzle arrangement 231.

The state in which the template 253 masks the region of the mold carrier 232 not covered by the accessory tile 33, is also shown in FIG. 7. It is denoted by the reference number 253′, and the coverings disposed on the webs 254′, 255′ are denoted by the reference numbers 251′ and 252′, respectively.

FIG. 8 depicts a top view onto the spray chamber 34, shown in FIG. 7, of the coloring agent coating installation 32. The walls 233 to 235 of spray chamber 34 and the robot unit 200 with the nozzle arrangement 231 are not shown in FIG. 8 for the sake of clarity. However, the state can be seen in which the template 253′ nearly completely masks the region of the mold carrier 232 which is not covered by the accessory tile 33. This region of the mold carrier 232, however, is preferably completely masked by the template 253′.

Also seen is the conveyor means 31 with hood 242 with the through-hole 243. The tracks 240, 241 disposed beneath the hood 242 are also visible. At the end of this track line formed by the tracks 240, 241 is disposed stop bar 260. Walls 245 and 246, which at least partially overlap the hood 242, include bearings 248, 261 and 247, 262, respectively, in which are disposed the articulation rods 249 and 250, respectively.

FIG. 9 is a section C-C through the core box 56 disposed in FIG. 3 on the shooting unit 50. However, of the shooting unit 50 only the plate-shaped element 122 with opening 136 is visible (cf. FIG. 5). The remainder of the shooting unit 50 is not depicted for the sake of clarity.

The upper core box 78 of core box 56 has on the side facing away from the lower core box 79 several bracings 270 to 272. Further can be seen a side wall 273 which is in connection with the bracings 270 to 272. The lower core box 79 also includes several bracings 274 to 276, which are in connection with a side wall 277. The lower core box 79 has furthermore a prominence 278 as well as a notching 279. On the prominence 278 of the lower core box 79 rests a mold carrier 280. The mold carrier 280 includes two webs 281, 282, wherein the one web 281 encompasses the prominence 278 of the lower core box 78 and the other web 282 engages into the notching 279. The mold carrier 280 is thereby fixedly disposed on the lower core box 79. Between the mold carrier 280 and an indentation 283 of the upper core box 78 an injection channel 284 can be seen, which has its greatest extent in the region of web 281 of mold carrier 280 and opening 136 of shooting plate 52. This extent is denoted as terminating edge 285. FIG. 9 shows further a milling-out 286 through which air can escape when concrete is injected into the injection channel 284. Therewith the compacted concrete can accumulate in the injection channel 284 as well as in the terminating edge 285. Since the concrete accumulated on the terminating edge 285 and on the milling-out 286 forms a burr on the accessory tile, such is cut off, as described in FIG. 6, by means of the cutting devices 171, 172.

In the proximity of the milling-out 286, furthermore, a screen nozzle 287 is disposed as a part of the lower core box 78. This screen nozzle 287 includes several openings 288 to 291, through which the air can escape from the core box 56 when concrete is injected into it.

While the screen nozzle 287 in FIG. 9 has several openings 288 to 291, however, it is feasible for this [nozzle] to have only a single opening. However, such a variant is not shown.

The at least one opening of the screen nozzle 287 must herein have such diameter that air, however not concrete, can leave the core box 56. It is understood that the screen nozzle 287 can also be disposed on the lower core box 79 or that the screen nozzle is formed by the lower core box 79 as well as also by the upper core box 78.

The screen nozzles can be disposed on the end of the injection channel or laterally on the injection channel. Since the screen nozzles lead to exhaust markings on the accessory tile, they are so disposed in the core box that, with respect to the accessory tile, they are disposed in regions where they are later no longer visible once they are installed. Milling-out can be employed in addition to the screen nozzles. The cross section of a milling-out is less than the diameter of the concrete particles such that these cannot escape from the core box. However, such millings-out are not depicted in FIG. 9.

FIG. 10 shows an exploded representation of the core box 56 shown in FIG. 9, however, rotated by 90 degrees in the clockwise direction. The plate-shaped element 122 is not depicted in FIG. 10. The upper core box 78, the lower core box 79 as well as the mold carrier 280 with a prominence 292 can again be seen. On the prominence 292 are disposed screen nozzles, of which in FIG. 10 two screen nozzles 293, 294 are visible. The screen nozzles 293, 294 serve as openings from which air between the lower core box 79 and the mold carrier 280 can escape when concrete is injected into the core box 56. Since the screen nozzles 293, 294 have only a small screen diameter, it is nearly impossible for the concrete to come between the lower core box 79 and the mold carrier 280. Through these screen nozzles 293, 294 disposed on the mold carrier 280 the air beneath an accessory tile 295 can escape.

The accessory tile 295 shown in FIG. 10 is an arris starting tile. Clearly visible is that this accessory tile 295 has a form which corresponds to that of the prominence 292 of mold carrier 280. Furthermore, side walls 273, 296 to 298 are visible. These side walls 273, 296 to 298 are connected with one another across an arrangement 299 comprised of several bracings 300 to 304. Although another arrangement 299 is also conceivable, it must always be structured such that it can withstand high pressures and high temperatures that are generated when concrete is introduced through the core shooting into the injection channel 284 of core box 56. However, the injection channel 284 is not visible in FIG. 10.

The lower core box 79 includes a lower part 305 on which an upper part 306 is disposed. On this upper part 306 is disposed the prominence 278, which includes the notching 279. This prominence 278 is so formed that on it the mold carrier 280 can be seated with accurate fit. The lower part 305 of the lower core box 79 further includes several openings 307 to 311, into which connection elements of the upper core box 78 can be introduced, wherein only the connection elements 312 to 314 of the upper core box 78 are evident. Furthermore is evident the milling-out 286 in the lower part 305. Through this milling-out 286 air can escape from the core box 56 via the screen nozzle 287 when green concrete is injected. The screen nozzle can also be disposed on walls 297 or 273. It is also feasible to provide several screen nozzles.

FIG. 11 depicts a further view of the core box 56 shown in FIG. 10, and, in particular, in a view obliquely from below. Evident are again the upper core box 78, the lower core box 79 and the mold carrier 280, which form the core box 56. The lower core box 79 of the core box 56 includes an arrangement 315 whose structure resembles that of the arrangement 299 of the upper core box 78.

Here side walls 316 to 319 are also connected with one another via bracings 320 to 322. As the arrangement 299, this arrangement 315 also serves for purpose for the core box 56 to withstand the temperatures and pressures generated when concrete is injected. Via the two webs 281, 282 the mold carrier 280 is placed onto the prominence 278 with accurate fit. However, prominence 278 is not visible in FIG. 11. Two screen nozzles 323, 324 are further visible. Seen can be further the connection elements 312 to 314, 325, 326 which serve for firmly connecting the upper core box 78 with the lower core box 79. Furthermore depicted is the accessory tile 295 which is formed when concrete is introduced into the injection channel 284 of the core box 56.

FIG. 12 depicts an exploded representation of a variant of the core box 56 shown in FIG. 10. This core box 330 is comprised of a lower core box 331, an upper core box 332 and a mold carrier 333. The accessory tile 334 produced with this core box 330 is a hip cap. Like the lower core box 79 of core box 56, this lower core box 331 of core box 330 also includes an arrangement 335 located between side walls 336 to 339 of lower core box 331. This arrangement 335 also serves in order for the core box 330 to withstand the high pressures as well as the high temperatures. The upper core box 332 includes connection pieces 340 to 344, by means of which the upper core box 332 can be firmly connected with the lower core box 331. The mold carrier 333 includes webs in the lower region, wherein only webs 345 and 346 are evident. Visible is further an upper part 347 of mold carrier 333 and an indentation 348 of the upper core box 332. The upper part 347 can herein be disposed in the indentation 348. The upper part 347 in this case is so spaced apart from the indentation 348 that here also an injection channel is formed such that, when injecting concrete into the core box 330, an accessory tile 334 is formed whose shape and size results precisely from the distance between the upper part 347 and the indentation 348.

In FIG. 12 there is moreover a screen nozzle 349 with openings 350 to 353 disposed on the upper core box 332. Openings 350 to 353 are of such a diameter that air, not however concrete, can escape from the core box 330. Although openings 350 to 353 in FIG. 12 are formed as slots, they can also have a different shape. It is, for example, conceivable for the screen nozzle 349 to have round openings. However, it is also conceivable that the diameter of the opening is so large that concrete can also leave through the opening. In this case it is necessary to dispose, for example, a net or grid in the opening such that concrete cannot leave the core box 330.

As already stated in the first embodiment example, it is feasible to dispose the screen nozzle 349 on the lower core box 331 or on the upper core box 332 as well as also on the lower core box 331.

FIG. 13 depicts a further view of core box 330 according to FIG. 12. The core box 330 has here been rotated so that the view is not directed in the direction of the underside of the upper core box 332. The core box 332 includes several walls 355 to 358 between which is located an arrangement 354. This arrangement 354 is also comprised of several interconnected bracings 359 to 363, which connect the walls 355 to 358 with one another. Arrangement 354 also serves for the core box 330 to withstand high temperatures and high pressure to which it is exposed during the injection of the concrete. Like the upper core box 78, this upper core box 332 also includes several connection elements with which the upper core box 332 can be connected with the lower core box 331. However, in FIG. 13 only connection elements 340 to 342 are visible. The lower core box 331 includes several connection sites 364 to 369 for the introduction of the connection elements 340 to 342 of the upper core box 332. Also visible is a milling-out 370 in the lower core box 331. The lower core box 331 includes, furthermore, a prominence 371 in which several notchings 372 to 375 are introduced. Into theses notchings 372 to 375 the webs of mold carrier 333 can be introduced such that the mold carrier 333 is firmly disposed on the lower core box 331.

In FIG. 13 can further be seen that the mold carrier 333 - as does also the mold carrier 280—includes screen nozzles 376 to 378. These screen nozzles 376 to 378 also serve for the purpose of the air being able to escape, which is between the mold carrier 333 and the prominence 371 of the lower core box 331 when concrete is injected into the core box 330.

FIG. 14 depicts an exploded representation of a further variant of the core box 56 shown in FIG. 10. This core box 400 is again comprised of a lower core box 401 and an upper core box 402 as well as a mold carrier 403. Further, an accessory tile 404 is depicted. The accessory tile 404 produced with this core box 400 is a venting tile.

The lower core box 401 also includes an arrangement 405 with several bracings 406 to 409 located between walls 410 to 413.

The mold carrier 403 includes on its underside several webs 414 to 417, which can engage into the notchings of a prominence disposed on the lower core box 401. However, in FIG. 14 the prominence as well as the notchings are not visible. Also not visible is a screen nozzle which is disposed on the lower core box 401. The upper core box 402 includes an indentation 418 in which the mold carrier 403 is at least partially disposed when the core box 400 is assembled. Between the indentation 418 and the mold carrier 403 is provided an injection channel into which the concrete is injected such that the accessory tile 404 is formed.

The upper core box 402 includes moreover several connection elements 419 to 423 as well as openings 424, 425, via which the upper core box 402 can be firmly connected with the lower core box 401. The upper core box 402 includes an arrangement with several bracings similar to the arrangement 405 of the lower core box 401, which arrangement, however, is not visible in FIG. 14.

It is understood that the arrangements 299, 315, 335, 354 and 405 shown in FIGS. 10 to 14 can also have a different shape. It is also feasible to omit such an arrangement if a core box is provided which is comprised of such a material or has such a shape that it permits withstanding the high pressure and temperatures generated during the injection.

The depicted notchings on the prominences of the lower boxes can also be implemented differently.

Based on FIGS. 10 to 14 it can therewith be shown that through variation of the core boxes, e.g. in particular of the shape of the prominences 278, 371, the mold carrier 280, 333, 403 disposed thereon as well of the indentations of the upper core boxes 78, 332, 402, accessory tiles of the most diverse shape can be produced. Even the production of roof decoration is feasible.

1. Method for producing roofing tiles by means of a core shooter device and a core box including a mold carrier, characterized by the following steps:
a) at least two components, of which the one component is water and the other component is cement, are placed into a mixer and mixed to form green concrete;
b) the green concrete is filled, by means of compressed air, through an injection opening of the core box into the core box;
c) the venting of the core box takes place via at least one screen nozzle disposed on the mold carrier;
d) the roofing tile formed in the core box is removed from the core box and transferred to a cutting device where projecting portions of the roofing tile are cut off.

2. Method as claimed in claim 1, characterized in that the roofing tile is an accessory tile.

3. Method as claimed in claim 1, characterized in that sand, water, cement, pigments and additives are dosed and supplied to the mixer.

4. Method as claimed in claim 3, characterized in that to the mixer are supplied 45 to 75 wt % sand (type 0/3), 0 to 24 wt % sand (type 0.5/2), 0 to 30 wt % quartz sand (type L 55), 18 to 25 wt % cement (type CEM II 52.5), 0.2 to 1.4 wt % additive (type FK 61), 0.2 to 0.8 wt % additive (type BWA 22) and 0.3 to 1.0 wt % coloring agent (type granite).

5. Method as claimed in claim 4, characterized in that to the mixer are supplied 54.13 wt % sand (type 0/3), 11.4 wt % sand (type 0.5/2), 5.7 wt % quartz sand (type L 55), 20.89 wt % cement (type CEM II 52.5), 0.47 wt % additive (type FK 61), 0.38 wt % additive (type BWA 22) and 0.5 wt % coloring agent (type granite).

6. Method as claimed in one of claims 3 to 5, characterized in that to the mixer are first supplied the solids and then, at the onset of the mixing process, the liquid components.

7. Method as claimed in claim 1, characterized in that the pressure of the compressed air is at least 4·10⁵ Pa, preferably 6·10⁵ Pa to 10·10⁵ Pa.

8. Method as claimed in claim 1, characterized in that the compressed air acts for 1 to 5 seconds onto the core box.

9. Method as claimed in claim 1, characterized in that before providing the core box a parting agent is applied onto the lower core box and onto the upper core box as well as onto the mold carrier.

10. Method as claimed in claim 1, characterized in that during the venting the air escapes via at least one screen nozzle disposed on the core box.

11. Method as claimed in claim 1, characterized in that the roofing tile is re-pressed during the cutting process.

12. Method as claimed in claim 1, characterized in that the roofing tile is provided with an outer coating after the cutting process.

13. Method as claimed in claim 12, characterized in that the roofing tile is provided with a coloring agent coating.

14. Method as claimed in one of claim 12 and claim 13, characterized in that after the coating the roofing tile is cured in a drying chamber at a temperature of at least 40° C. and an air humidity of at least 65%.

15. Method as claimed in claim 14, characterized in that the roofing tile dwells for 6 to 10 hours in the drying chamber.

16. Device for producing roofing tiles, wherein the device includes a core shooter device as well as a core box comprising a mold carrier, characterized by the following distinguishing features:
a) a mixer is provided for the production of green concrete, wherein the green concrete comprises at least the components water and cement;
b) the core box comprises an injection opening;
c) a cutting device is provided which cuts off projecting portions of the roofing tile.
